(19) United States
(12) Patent Application Publication
(10) Pub. No.: US 2020/0185677 A1
(43) Pub. Date: Jun. 11, 2020

(54) LITHIUM SECONDARY BATTERY AND MANUFACTURING METHOD THEREOF

(71) Applicants: Hyundai Motor Company, Seoul (KR); Kia Motors Corporation, Seoul (KR)

(72) Inventors: Dongjun Kim, Seongnam-si (KR); Yeolmae Yeo, Anseong-si (KR); Yoon Sung Lee, Suwon-si (KR); Jieun Lee, Hwaseong-si (KR); KiSeok Koh, Suwon-si (KR); Seung-Min Oh, Incheon (KR)

(21) Appl. No.: 16/572,081

(22) Filed: Sep. 16, 2019

(30) Foreign Application Priority Data
Dec. 11, 2018 (KR) 10-2018-0159531

(51) Int. Cl. H01M 2/16; H01M 4/62; H01M 10/0525

(52) U.S. Cl. CPC H01M 2/168; H01M 10/0525; H01M 4/622

(57) ABSTRACT

A lithium secondary battery is disclosed, comprising an electrode including a binder having an alkene group (—C═C—); a separator substrate; and an adhesive layer, which includes a thiol group (—SH), provided between the electrode and the separator substrate so that the electrode and the separator substrate are bonded to each other.

### CROSS-REFERENCE TO RELATED APPLICATION(S)

This application claims priority to and the benefit of Korean Patent Application No. 10-2018-0159531, filed on Dec. 11, 2018 in the Korean Intellectual Property Office, the disclosure of which is incorporated by reference in its entirety.

### BACKGROUND

Embodiments of the present disclosure relate to a lithium secondary battery and manufacturing method thereof.

In general, a lithium secondary battery including an electroactive material has a high operating voltage and high energy density compared to a lead battery or a nickel/cadmium battery. Accordingly, the lithium secondary battery is widely used as energy storage devices for an Electric Vehicle (EV) and a Hybrid Electric Vehicle (HEV).

Energy densification of batteries is the most important issue to increase travelling distance of electric vehicles. To achieve this, the capacity of the anode and cathode materials used must be increased or the electrode must be thickened.

In the process of thickening the electrode, it is necessary to introduce a low-viscosity solvent into the electrolyte to ensure the performance of the lithium secondary battery. However, since the low-viscosity solvent has low boiling point, electrolyte loss due to volatilization during cell driving may occur, which may result in poor stability at high temperatures. In addition, there is a problem that gas is generated from the solvent and deintercalation occurs between the electrode and the separator.

In the currently commercially available adhesive type separator, the polymer coated on the separator and the binder of the electrode are swelled in the electrolyte and physically bonded to each other.

However, such a physical bonding method may not secure a sufficient adhesive force, and as the size of the cell increases, it is difficult to realize uniform adhesion between the electrode and the separator as a whole. Accordingly, it is necessary to develop a lithium secondary battery capable of further improving the adhesion between the electrode and the separator to solve the above problems.

### SUMMARY

Therefore, it is an aspect of the present disclosure to provide a lithium secondary battery having improved adhesion between an electrode and a separator by utilizing chemical bonding through a thiol-ene click reaction, and a method for manufacturing the same.

In accordance with an aspect of the present disclosure, a lithium secondary battery includes: an electrode comprising a binder having an alkene group (—C═C—); a separator substrate; and an adhesive layer comprising a thiol group (—SH) between the electrode and the separator substrate so that the electrode and the separator substrate are bonded to each other.

The adhesive layer is prepared by mixing a ceramic particle and a polymer having a thiol group.

The adhesive layer includes a ceramic particle layer and a polymer layer disposed on the ceramic particle layer, wherein the polymer layer comprises a polymer having a thiol group.

The polymer having a thiol group may be obtained by introducing a thiol group into a polymer through a chemical reaction, wherein the polymer includes at least one selected from the group consisting of polyvinylidene fluoride, polyvinyl pyrrolidone, polymethyl methacrylate, polybutyl acrylate, polyvinylidene fluoride, and copolymers thereof.

The binder having an alkene group may be obtained by introducing an alkene group into a compound through a chemical reaction, wherein the compound is selected from the group consisting of styrene-butadiene rubber, carboxymethylcellulose, and polyvinylidene fluoride.

The ceramic particle includes at least one ceramic selected from the group consisting of alumina, boehmite, magnesium oxide, titanium oxide, and aluminum nitride.

The adhesive force between the separator substrate and the electrode is 30 gf/mm or more at a temperature of 70° C. or more and a pressure of 1 MPa or more.

In accordance with an aspect of the present disclosure, a method of manufacturing a lithium secondary battery includes: preparing a separator by thiol-modifying a surface of the separator; preparing an electrode including a cathode and an anode on which a binder layer containing carbon double bonds is disposed; and bonding the electrode to the separator.

The preparing the separator includes: immersing an adhesive polymer in an aqueous solution acquired by mixing potassium permanganate (KMnO₄) and potassium hydroxide (KOH); and producing a polymer having a thiol group by reacting the immersed adhesive polymer with hydrochloric acid (HCl) and 3-mercaptopropionic acid (MPA).

The adhesive polymer includes at least one polymer material selected from the group consisting of polyvinylidene fluoride, polyvinyl pyrrolidone, polymethyl methacrylate, polybutyl acrylate, polyvinylidene fluoride, and copolymers thereof.

The preparing the electrode includes: forming a carbon double bond by immersing the binder in an aqueous solution of lithium hydroxide (LiOH).

The binder includes at least one selected from the group consisting of styrene-butadiene rubber, carboxymethylcellulose, and polyvinylidene fluoride.

The bonding the electrode to the separator includes: heating the separator and the electrode under a static pressure in a state where the separator and the electrode are immersed in the electrolyte.

The bonding the electrode to the separator includes: adding an azo-based or peroxide-based compound as the reaction initiator.

### BRIEF DESCRIPTION OF THE DRAWINGS

These and/or other aspects of the disclosure will become apparent and more readily appreciated from the following description of embodiments, taken in conjunction with the accompanying drawings.

FIG. 1 is a cross-sectional view of a lithium secondary battery according to a disclosed embodiment.

FIG. 2 is an enlarged view of an adhesive layer of a lithium secondary battery according to a disclosed embodiment.

FIG. 3 illustrates an adhesive polymer and an electrode binder having a functional group substituent according to a disclosed embodiment.

FIG. 4 illustrates a process for producing a polymer having a thiol group.

FIG. 5 illustrates a process for manufacturing a binder having an alkene group.

### DETAILED DESCRIPTION

Like numbers refer to like elements throughout this specification. This specification does not describe all components of the embodiments, and the general information in the technical field to which the present disclosure belongs or the overlapping information between the embodiments will not be described.

Also, it will be understood that the terms “includes,” “comprises,” “including,” and/or “comprising” when used in this specification, specify the presence of a stated component, but do not preclude the presence or addition of one or more other components.

It is to be understood that the singular forms “a,” “an,” and “the” include plural referents unless the context clearly dictates otherwise.

Hereinafter, embodiments of the present disclosure will be described in detail with reference to the accompanying drawings and tables. First, the lithium secondary battery will be described, and then the adhesive type separator for a lithium secondary battery according to the disclosed embodiment will be described in detail.

Generally, a lithium secondary battery includes a cathode, an anode, a separator, and an electrolyte. The cathode, the anode, and the electrolyte may be implemented using components typically used to manufacture a lithium secondary battery.

An electrode may be formed by applying a predetermined thickness of an electrode slurry having a mixture of an electrode active material, a binder and solvent, and a conductive material to an electrode current collector, and then drying and rolling the electrode slurry.

The electrode current collector may include a material having high conductivity without causing a chemical change in the lithium secondary battery. For example, the electrode current collector may be made of stainless steel, aluminum, nickel, titanium, sintered carbon, or a surface treated with carbon, nickel, titanium or silver on the surface of aluminum or stainless steel. It is possible to form fine irregularities on the surface of the current collector to increase the adhesive force of the cathode active material and it can be realized in various forms such as a film, a sheet, a foil, a net, a porous body, a foam, and a nonwoven fabric.

An anode active material which is used to manufacture the anode may be provided using any anode active material that can intercalate and deintercalate lithium ions. The anode active material may include at least one selected from the group consisting of a material capable of reversibly intercalating and deintercalating lithium ions, a metal material forming an alloy with lithium, mixtures thereof, or a combination thereof.

The material capable of reversibly intercalating and deintercalating lithium ions may be at least one material selected from the group consisting of synthetic graphite, natural graphite, graphitized carbon fiber, graphitized mesocarbon microbeads (MCMB), fullerene, and amorphous carbon.

The amorphous carbon may be hard carbon, coke, MCMB and mesophase pitch-based carbon fiber (MPCF) sintered at the temperature of 1500° C. or lower, or the like. Also, the metal material capable of forming an alloy with lithium may be at least one metal selected from the group consisting of aluminum (Al), silicon (Si) tin (Sn), lead (Pb), zinc (Zn), bismuth (Bi), indium (In), magnesium (Mg), gallium (Ga), cadmium (Cd), nickel (Ni), titanium (Ti), manganese (Mn), and germanium (Ge). The metal materials may be used alone, in combination, or in an alloy. Also, the metal may be used as a compound mixed with a carbon-based material.

The anode active material may include silicon. The anode active material may also include graphite-silicon composites. The anode active material including silicon includes silicon oxide, silicon particles, silicon alloy particles, and the like. Representative examples of the alloy include a solid solution of aluminum (Al), manganese (Mn), iron (Fe), titanium (Ti), etc. with a silicon element, an intermetallic compound, an eutectic alloy, etc., but the alloys according to the present disclosure are not limited thereto.

A cathode active material that is used to manufacture the cathode according to the embodiment may include a compound allowing reversible intercalation and deintercalation of lithium. More specifically, the cathode active material may be at least one type of a compound oxide of lithium and a metal selected from the group consisting of cobalt, manganese, nickel, and a combination thereof.

The conductive material is for improving electrical conductivity and includes an electron conductive material that does not cause a chemical change in the lithium secondary battery. For example, graphite such as natural graphite or artificial graphite; carbon black such as carbon black, acetylene black, ketjen black, channel black, furnace black, lamp black, and summer black; conductive fibers such as carbon fiber and metal fiber; metal powders such as carbon fluoride, aluminum, and nickel powder; conductive whiskey such as zinc oxide and potassium titanate; conductive metal oxides such as titanium oxide; conductive materials such as polyphenylene derivatives and the like may be used.

Examples of the binder include carboxymethyl cellulose (CMC), styrene-butadiene rubber (SBR), which is a water-based binder used for the anode, and polyvinylidene fluoride (PVDF) used for the cathode.

When the anode includes a graphite and silicon composite, the binder may include a binder mixture comprising: a water-based binder, such as CMC/SBR used in a graphite-based anode for improving the adhesion; and a polymer binder, such as heparin, Dopamine-polymerized heparin and LiPAA (lithium polyacrylate), for increasing the adhesion strength of a silicon-based anode and suppressing the volume expansion of the silicon-based anode.

The lithium secondary battery according to the present disclosure includes an adhesive layer provided between the electrode and the separator for bonding the electrode and the separator. The bonding between the electrode and the separator may be provided through a chemical bonding between a polymer having a thiol group (—SH) and a binder having an alkene group (—C═C—) which is present when an adhesive layer is formed. Details of this will be described later.

The electrode according to the embodiment may further include other additives, such as a dispersion medium, a viscosity modifier, and a filling material, in addition to the electrode active material, a conductive material, and the binder having an alkene group described above.

The electrolyte may include lithium salt and a non-aqueous organic solvent, and may further include an additive for improving the charging/discharging characteristics and preventing overcharging. The lithium salt may comprise, for example, a mixture of one or more materials selected from the group consisting of LiPF₆, LiBF₄, LiClO₄, LiCl, LiBr, LiI, LiBioCl₁₀, LiCF₃SO₃, LiCF₃CO₂, LiAsF₆, LiSbF₆, LiAlCl₄, CH₃SO₃Li, CF₃SO₃Li, LiN(SO₂C₂F₅)₂, Li(CF₃SO₂)₂N, LiC₄F₉SO₃, LiB(C₆H₅)₄, Li(SO₂F)₂N (LiFSI) and (CF₃SO₂)₂NLi.

The non-aqueous organic solvent may be carbonate, ester, ether, or ketone, which may be used alone or in combination. The carbonate may include but is not limited to dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC), fluoroethylene carbonate (FEC), or vinylene carbonate (VC), etc. The ester may include but is not limited to γ-butyrolactone (GBL), n-methyl acetate, n-ethyl acetate, n-propyl acetate, etc. The ether may include but is not limited to dibutyl ether.

Also, the non-aqueous organic solvent may further include an aromatic hydrocarbon organic solvent. Examples of the aromatic hydrocarbon organic solvent may be benzene, fluorobenzene, bromobenzene, chlorobenzene, cyclohexylbenzene, isopropyl benzene, n-butylbenzene, octyl benzene, toluene, xylene, mesitylene, etc., which may be used alone or in combination.

The separator is provided for a path for lithium ion movement in the lithium secondary battery and for physically separating both electrodes. As long as it is generally used as a material of a separator in a lithium secondary battery, it can be used without any particular limitation. Particularly, it is preferable that the separator has low resistance to ion movement of the electrolyte and excellent electrolyte wettability.

The conventional porous polymer film, for example, a porous polymer film made of a polyolefin-based polymer such as an ethylene homopolymer, a propylene homopolymer, an ethylene/butene copolymer, an ethylene/hexene copolymer, and an ethylene/methacrylate copolymer, may be used alone or in a laminated form as a separator substrate.

Also, according to the disclosed embodiment, a ceramic coated separator (CCS) may be used. The ceramic coating may be formed using one or more ceramics such as alumina, boehmite, magnesium oxide, titanium oxide, and aluminum nitride.

On the other hand, a method is employed in which an adhesive layer is applied between the separator and the electrode so as to prevent separation between the electrode and the separator and to prevent leakage of the electrolyte. However, such a method also may not secure a sufficient adhesive force by adopting a physical bonding method, and it is difficult to achieve uniform adhesion between the electrode and the separator as the cell size increases.

The disclosed embodiment provides a lithium secondary battery having improved adhesion between an electrode and a separator by replacing a functional group capable of chemical reaction with an adhesive polymer and a binder of the separator.

Hereinafter, the adhesive type separator of a lithium secondary battery according to the disclosed embodiment will be described in detail.

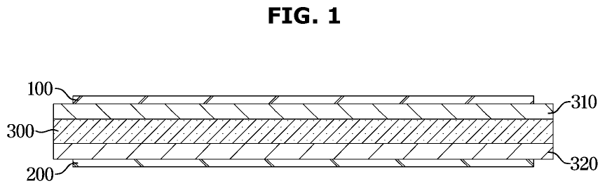

FIG. 1 is a cross-sectional view of a lithium secondary battery according to a disclosed embodiment.

As shown in FIG. 1, the lithium secondary battery according to the disclosed embodiment includes a separator substrate 300; an electrode including a cathode 100 and an anode 200 bonded to both surfaces of the separator substrate; and an adhesive layer 310, 320 provided between the electrode and the separator substrate so that the electrode and the separator substrate are adhered to each other.

The adhesive layer includes a polymer having a thiol group (—SH). Specifically, the thiol group included in the adhesive layer and the alkene group included in the binder of the electrode can improve the adhesion between the electrode and the separator by utilizing a chemical bond through a thiol-ene click reaction.

The thiol group and the alkene group are substituted functional groups (FG) so that the adhesive polymer of the separator and the binder of the electrode can chemically react.

The adhesive layers 310 and 320 may be formed to have a thickness of 0.5 to 2 μm so as not to affect the total volume of the lithium secondary battery while stably maintaining the bonding between the electrode and the separator. When the thickness of the adhesive layer is too thin, the desired bonding force may not be obtained. On the contrary, if the thickness of the adhesive layer is too thick, there is a problem that the capacity and output of the lithium secondary battery are lowered as the internal resistance increases.

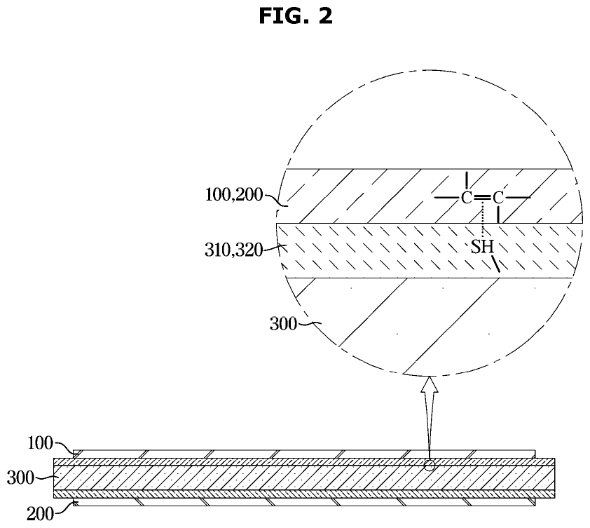

FIG. 2 is an enlarged view of an adhesive layer of a lithium secondary battery according to a disclosed embodiment.

Referring to FIG. 2, the adhesive layers 310 and 320 are provided on the separator substrate 300 and include a polymer having a thiol group.

The adhesive layers 310 and 320 may be formed by mixing ceramic particles and a polymer having a thiol group.

The ceramic particles may be manufactured using one or more ceramics selected from the group consisting of alumina, boehmite, magnesium oxide, titanium oxide, and aluminum nitride.

The adhesive polymer is not particularly limited as long as it can secure the adhesion between the electrode and the separator. However, it is preferable to use a material exhibiting an adhesive force only when the temperature is raised during the production of the lithium secondary battery. For example, the adhesive polymer may include at least one polymer selected from the group including polyvinylidene fluoride, polyvinyl pyrrolidone, polymethyl methacrylate, polybutyl acrylate, polyvinylidene fluoride, and copolymers thereof.

The adhesive layers 310 and 320 may be formed in a multilayer structure in which a ceramic particle layer (not shown) is provided and a polymer layer including a polymer having a thiol group (not shown) is provided on the ceramic particle layer. At this time, the adhesive layers 310 and 320 may be provided by introducing the thiol group, which is a functional group, into the adhesive polymer.

On the other hand, the above-mentioned thiol group may react with an alkene group which is included in the electrode binder as a functional group.

Examples of the electrode binder include a binder compound such as carboxymethyl cellulose (CMC), styrene-butadiene rubber (SBR), which is a water-based binder used for the anode, and polyvinylidene fluoride (PVDF), polyvinylidene fluoride-hexafluoropropylene (PVDF-co-HFP) used for the cathode.

At this time, the functional group in the adhesive polymer of the separator and the functional group of the electrode binder should be able to react with each other. In the disclosed exemplary embodiment, the functional group in the adhesive polymer of the separator and the functional group of the electrode binder may react through a thiol-ene click reaction.

The thiol group may be disposed on the electrode or the separator, and an alkene group may be disposed on the other. In the disclosed embodiment, a thiol group is disposed on the separator and an alkene group is disposed on the electrode. However, if the thiol-ene click reaction occurs, the functional groups may be arranged in various ways.

Referring to FIG. 2, a thiol group of the adhesive layers 310 and 320 may react with an alkene group in the electrodes 100 and 200 through a thiol-ene click reaction. The thiol-ene click reaction may proceed with a crosslinking reaction even at a low energy. For example, the thiol-ene click reaction may proceed with a crosslinking reaction at a temperature of 70° C. or higher and a pressure of 1 MPa or higher.

At this time, the adhesive force between the separator substrate and the electrode may be 30 gf/mm or more.

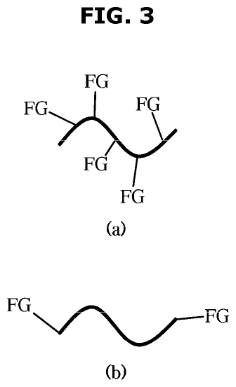

FIG. 3 illustrates an adhesive polymer and an electrode binder having a functional group substituted according to a disclosed embodiment. Referring to FIG. 3, when a general polymer is represented by a chain, the functional group (FG) may be bonded to the middle of the polymer chain or may be bonded to both ends of the chain. A specific substitution method of the functional group will be described later.

Hereinafter, a method of manufacturing an adhesive type separator according to the disclosed embodiment will be described.

A method of manufacturing a lithium secondary battery according to the disclosed embodiment includes: preparing a separator comprising an adhesive polymer by thiol-modifying a surface of separator; preparing an electrode including a cathode and an anode on which a binder layer containing carbon double bonds is disposed; and bonding the electrode to the separator.

The adhesive polymer is applied onto a prepared porous separator substrate. The adhesive polymer is applied to both surfaces of the porous separator substrate, and is then formed into an adhesive layer including a polymer having a thiol group through a series of processes.

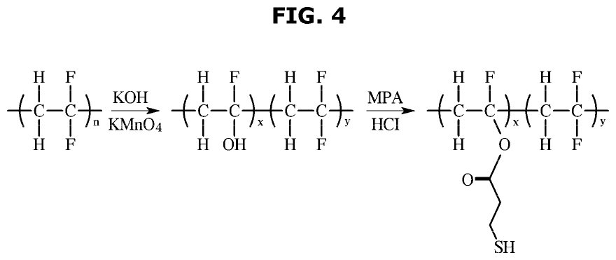

FIG. 4 illustrates a process for producing a polymer having a thiol group. The adhesive polymer is described using polyvinylidene fluoride (PVDF) as an example.

PVDF is immersed in an aqueous solution acquired by mixing potassium permanganate (KMnO₄) and potassium hydroxide (KOH) to replace a certain amount of fluorine with an —OH group.

Then, the PVDF substituted with the —OH group may be immersed in an aqueous solution of sodium bisulfite to neutralize the PVDF.

Then, thiol-substituted PVDF may be synthesized by reacting the —OH-substituted PVDF with hydrochloric acid (HCl) and 3-mercaptopropionic acid (MPA).

A separator may be prepared by coating the polymer having the thiol group on both sides of the separator.

In one exemplary embodiment, an adhesive layer may be formed on both surfaces of a separator substrate by applying a mixture of ceramic particles and a polymer having thiol groups to the separator substrate.

In one exemplary embodiment, an adhesive layer may have a multi-layer structure in which a ceramic particle layer is formed on both surfaces of a separator substrate, and a polymer layer including a polymer having a thiol group is provided on the ceramic particle layer.

Next, a binder compound is applied onto a prepared electrode current collector. Examples of the binder compound include carboxymethyl cellulose (CMC), styrene-butadiene rubber (SBR), which is a water-based binder used for the anode, and polyvinylidene fluoride (PVDF) used for the cathode.

The binder compound, which includes an alkene group, is applied to one surface of the electrode current collector, thereby producing an electrode binder.

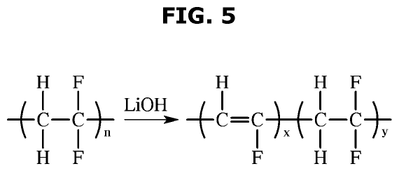

FIG. 5 illustrates a process for manufacturing a binder having an alkene group. The process for manufacturing a binder is explained by using polyvinylidene fluoride (PVDF) as the cathode binder and stadiene butadiene rubber (SBR) as the anode binder.

Referring to FIG. 5, when PVDF, which is a cathode binder, is immersed in an aqueous solution of lithium hydroxide (LiOH) and reacted with the stuttering, On the basis of the PVDF monomer, fluorine and hydrogen are eliminated one by one to form a carbon double bond, so that PVDF substituted with an alkene group may be synthesized.

In the case of SBR, the carbon double bond (C═C) is already present and the SBR does not have to undergo the above process. However, in the case of an anode binder having no carbon double bond, the alkene group may be substituted by applying the process described above.

The electrodes may be prepared by applying an electrode slurry obtained by mixing a binder having a synthesized alkene group, an electrode active material, a conductive material, and a solvent on one surface of an electrode current collector, and by drying and rolling the electrode current collector coated with the slurry.

Next, a step of bonding an electrode to the separator is performed. That is, the separator manufactured according to the above-described method is interposed between the cathode and the anode inside the pouch. Thereafter, an electrode assembly in which the separator and the electrode are adhered through an electrolyte impregnation and pressing process may be manufactured.

At this time, the pressing step may be carried out by heating the separator and the electrode in a state of being impregnated with the electrolytic solution under the static pressure. That is, in a state where a physically constant pressure is applied to the cathode and the anode, the thiol-ene click reaction may be caused by raising the temperature.

For example, the thiol-ene click reaction may be conducted at a temperature of 70° C. or higher and a pressure of 1 MPa or higher.

As an initiator for the thiol-ene click reaction, an azo-based or peroxide-based compound may be added.

For example, the initiator may be selected from at least one of an azo-based compound including 2,2′-azobis (2-cyanobutane), 2,2′-azobis (methylbutyronitrile), 2,2′-Azobis(iso-butyronitrile) (AlBN), 2,2′-azobisdimethyl-valeronitrile (AMVN) and the like, and a peroxide-based compound including benzoyl peroxide (BPO), lauryl peroxide, octanoyl peroxide, dicumyl peroxide and the like, as a thermal initiator.

Hereinafter, adhesiveness of a lithium secondary battery separator according to an embodiment of the present disclosure will be described with reference to examples and comparative examples. However, the following examples are provided to aid understanding of the present disclosure, and the scope of the present disclosure is not limited to the following examples.

In order to carry out a test for evaluation of adhesion, lithium secondary batteries of Examples and Comparative Examples were prepared according to the conditions shown in Table 1 below.

### Example 1

94 wt % of carbon powder as the anode active material, 2 wt % of styrene-butadiene rubber (SBR) and 1 wt % of carboxymethyl cellulose (CMC) as binder, and 3 wt % of Super-P as a conductive material were added to water (H₂O) to prepare an anode mixture slurry. The slurry was coated on both sides of a copper foil as a current collector, dried and compressed to prepare an anode.

Li(Ni_{0.6}Co_{0.2}Mn_{0.2})O₂ as a cathode active material, polyvinylidene fluoride (PVDF) as a binder and carbon as a conductive material were mixed at a weight ratio of 93:3:4 and dispersed in N-methyl-2-pyrrolidone to prepare a cathode slurry. An aluminum foil was coated with the prepared cathode slurry, dried and pressed to produce a cathode.

A porous polyolefin was used as a separator substrate, both surfaces of the separator substrate were coated with a slurry including water and polyvinylidene fluoride (PVDF) having a thiol group and dried to prepare a separator.

A pouch type lithium secondary battery was manufactured by disposing the separator between the cathode and the anode in the pouch, performing a pressing process in which an electrolyte(Ethylene carbonate (EC)/propylene carbonate (PC)/diethyl carbonate (DEC)=3/2/5 (volume ratio) and 1 mol of lithium hexafluorophosphate (LiPF₆)) was injected and heated to 80° C. for 5 minutes under a pressure of 1 Mpa and bonding an electrode and a separator.

As the reaction initiator, an azo-based compound AIBN (2,2′-Azobis (iso-butyronitrile)) was added.

### Example 2

A lithium secondary battery was produced in the same manner as in Example 1, except that PVDF, in which alkene groups were substituted by immersing in a LiOH aqueous solution, was used as the cathode binder.

### Comparative Example

A lithium secondary battery was produced in the same manner as in Example 1 except that polyvinylidene fluoride (PVDF) was used as the adhesive polymer applied to the separator substrate and AIBN (2,2′-Azobis (iso-butyronitrile)), which is a reaction initiator, was not used.

The electrode assemblies manufactured according to Examples 1 and 2 and Comparative Example were cut to a predetermined size and fixed on a slide glass, and then the peel strength between the separator and the electrode was measured using a 180° peel strength meter while peeling the separator.

TABLE 1

| | | | | | Comparative | |
|---|---|---|---|---|---|---|
| | Example 1 | | Example 2 | | Example | |
| Separator | PVDF | | PVDF | | PVDF | |
| adhesive layer | having a | | having a | | | |
| polymer | thiol group | | thiol group | | | |
| Anode binder | SBR | | SBR | | SBR | |
| Cathode binder | PVDF | | LiOH-treated PVDF | | PVDF | |
| | An- | Cath- | An- | Cath- | An- | Cath- |
| | ode | ode | ode | ode | ode | ode |
| Peel | 35.3 | 15.2 | 33.6 | 37.5 | 8.2 | 14.6 |
| strength(gf/mm) | | | | | | |

As shown in Table 1, the peeling strength between the anode and the separator of the lithium secondary battery of Example 1 using PVDF having a thiol group as the adhesive polymer applied to the separator substrate was measured to 35.3 gf/mm, and it was confirmed that adhesive strength of the lithium secondary battery of Example 1 was relatively superior to that of the lithium secondary battery according to the Comparative Example.

In Example 1, the PVDF having a thiol group applied to the separator substrate was subjected to a thiol-ene click reaction with the SBR having the carbon double bond coated on the anode but did not react with the existing PVDF applied to the cathode. Therefore, only the adhesion between the anode and the separator was improved.

In addition, in Example 2 using the PVDF having an alkene group as the cathode binder, not only the peel strength between the anode and the separator was measured as 33.6 gf/mm, but also the peel strength between the cathode and separator was measured as 37.5 gf/mm. That is, the adhesion between the cathode and the separator and the adhesion between the anode and the separator were improved as compared with the comparative example.

In Example 2, the PVDF having a thiol group applied to the separator substrate was subjected to a thiol-ene click reaction with the PVDF having a carbon double bond applied to the cathode, thereby improving the adhesion between the cathode and the separator.

As a result, the lithium secondary battery according to the disclosed embodiment may improve the adhesion between the separator and the electrode by introducing substituted functional groups into the adhesive polymer of the separator and the binder of the electrode. Accordingly, the lithium secondary battery according to the disclosed embodiment may reduce the amount of the electrolyte additive, thereby securing the price competitiveness of the lithium secondary battery.

The lithium secondary battery according to the disclosed embodiment can improve the adhesion between the electrode and the separator by utilizing the chemical bond through the thiol-ene click reaction and reduce the amount of the electrolyte additive, thereby securing the price competitiveness of the lithium secondary battery.

Although a few embodiments of the present disclosure have been shown and described, it would be appreciated by those skilled in the art that changes may be made in these embodiments without departing from the principles and spirit of the invention, the scope of which is defined in the claims and their equivalents.

What is claimed is:

1. A lithium secondary battery comprising:
an electrode comprising a binder including an alkene group (—C═C—);
a separator substrate; and
an adhesive layer disposed between the electrode and the separator substrate so that the electrode and the separator substrate are bonded to each other,
wherein the adhesive layer comprises a thiol group (—SH).

2. The lithium secondary battery according to claim 1, wherein the adhesive layer comprises a ceramic particle and a polymer having a thiol group.

3. The lithium secondary battery according to claim 1, wherein the adhesive layer comprises: a ceramic particle layer; and a polymer layer disposed on the ceramic particle layer, wherein the polymer layer comprises a polymer having a thiol group.

4. The lithium secondary battery according to claim 2, wherein the polymer having the thiol group comprises at least one polymer material selected from the group consisting of polyvinylidene fluoride, polyvinyl pyrrolidone, polymethyl methacrylate, polybutyl acrylate, polyvinylidene fluoride, and copolymers thereof.

5. The lithium secondary battery according to claim 1, wherein the binder comprising an alkene group comprises at least one selected from the group consisting of styrene-butadiene rubber, carboxymethylcellulose, and polyvinylidene fluoride.

6. The lithium secondary battery according to claim 3, wherein the ceramic particle comprises at least one ceramic selected from the group consisting of alumina, boehmite, magnesium oxide, titanium oxide, and aluminum nitride.

7. The lithium secondary battery according to claim 1, wherein an adhesive force between the separator substrate and the electrode is 30 gf/mm or more at a temperature of 70° C. or more and a pressure of 1 MPa or more.

8. A method of manufacturing a lithium secondary battery comprising:
preparing a separator by thiol-modifying the surface;
preparing an electrode including a cathode and an anode on which a binder layer containing carbon double bonds is disposed; and
bonding the electrode to the separator.

9. The method according to claim 8, wherein the preparing the separator comprises:
immersing an adhesive polymer in an aqueous solution comprising potassium permanganate (KMnO₄) and potassium hydroxide (KOH); and
producing a polymer having a thiol group by reacting the immersed adhesive polymer with hydrochloric acid (HCl) and 3-mercaptopropionic acid (MPA).

10. The method according to claim 9, wherein the adhesive polymer comprises at least one polymer material selected from the group consisting of polyvinylidene fluoride, polyvinyl pyrrolidone, polymethyl methacrylate, polybutyl acrylate, polyvinylidene fluoride, and copolymers thereof.

11. The method according to claim 8, wherein the preparing the electrode comprises:
forming a carbon double bond by immersing a binder compound in an aqueous solution of lithium hydroxide (LiOH).

12. The method according to claim 11, wherein the binder compound comprises at least one selected from the group consisting of styrene-butadiene rubber, carboxymethylcellulose, and polyvinylidene fluoride.

13. The method according to claim 8, wherein the bonding the electrode to the separator comprises:
heating the separator and the electrode under a static pressure in a state where the separator and the electrode are immersed in an electrolyte.

14. The method according to claim 8, wherein the bonding the electrode to the separator comprises:
adding an azo-based or peroxide-based compound as a reaction initiator.
